(19) United States
(12) Patent Application Publication
(10) Pub. No.: US 2026/0125583 A1
(43) Pub. Date: May 7, 2026

(54) ADHESIVE WITH PRESSURE REGULATION FUNCTION

(71) Applicant: NITTA CORPORATION, Osaka-shi, Osaka (JP)

(72) Inventors: Takumi KATO, Yamatokohriyama-shi (JP); Keisuke SAKO, Yamatokohriyama-shi (JP)

(73) Assignee: NITTA CORPORATION, Osaka-shi, Osaka (JP)

(21) Appl. No.: 19/120,325

(22) PCT Filed: Oct. 6, 2023
(86) PCT No.: PCT/JP2023/036547

§ 371 Date: Apr. 11, 2025

(30) Foreign Application Priority Data
Oct. 14, 2022 (JP) 2022-165239

(51) Int. Cl. C09J 133/08; C09J 7/38; C09J 11/08

(52) U.S. Cl. CPC C09J 133/08; C09J 7/385; C09J 11/08; C09J 2433/00

(57) ABSTRACT

An adhesive with a pressure regulation function of the present invention is the adhesive configured to be adhered to a resin adherend including a vapor release port in order to seal the vapor release port. Adhesive strength reduces by heat of vapor released from the vapor release port, and peeling occurs to release vapor by pressure of vapor. The adhesive is capable of resealing the vapor release port after vapor release, and no external force may be required for resealing. The adhesive may include a pressure sensitive adhesive, and a side chain crystalline polymer including, as a monomer component, (meth)acrylate having a straight-chain alkyl group with a carbon number of 12 to 30.

### TECHNICAL FIELD

The present invention relates to an adhesive with a pressure regulation function.

### BACKGROUND

When a closed container is heated, the container may expand and burst due to water vapor generated along with warming. With respect to this problem, many technologies have been proposed which are configured to add a vapor discharge function by putting a lot of thought into a lid and an adhesive tape of the container. For example, Patent Document 1 proposes a configuration where a heat shrinkable film is applied, and the film shrinks to discharge vapor during heating.

However, with a conventional configuration as proposed in Patent Document 1, a vapor discharge port remains open after discharging the vapor. Hence, there have been possibilities of a leak of a content and a burn injury by discharge of remaining vapor. There have also been concerns that a foreign matter enters the inside, etc.

In order to improve the above problems, for example, Patent Document 2 proposes a configuration where an adhesive label peels off by a vapor internal pressure, and resealing is supported by rigidity of a base material.

However, the configuration proposed by Patent Document 2 requires an operation (external force), such as affixing by hand when resealing. Consequently, there remains a concern about a burn injury when resealing, due to heat of vapor slightly released even after heating.

### RELATED ART DOCUMENTS

### Patent Documents

Patent Document 1: Japanese Unexamined Patent Publication No. 2016-60531
Patent Document 2: Japanese Patent No. 6771281

### SUMMARY OF THE INVENTION

### Problems to be Solved by the Invention

It is an object of the present invention to provide an adhesive with a pressure regulation function which is excellent in sealing properties and vapor releasability.

### Means for Solving the Problem

An adhesive with a pressure regulation function of the present invention is the adhesive configured to be adhered to a resin adherend including a vapor release port in order to seal the vapor release port. Adhesive strength reduces by heat of vapor released from the vapor release port, and peeling occurs to release vapor by pressure of vapor.

### Effects of the Invention

With the present invention, there are the effects of being excellent in sealing properties and vapor releasability.

### BRIEF DESCRIPTION OF THE DRAWINGS

FIG. 1 is a sectional view of an adhesive with a pressure regulation function (an adhesive tape with a pressure regulation function) according to an embodiment of the present invention, and an adherend, specifically illustrating a state before vapor release;

FIG. 2 is a sectional view of an adhesive with a pressure regulation function (an adhesive tape with a pressure regulation function) according to an embodiment of the present invention, and an adherend, specifically illustrating a state where pressure increases by vapor generation;

FIG. 3 is a sectional view of an adhesive with a pressure regulation function (an adhesive tape with a pressure regulation function) according to an embodiment of the present invention, and an adherend, specifically illustrating a state of vapor release;

FIG. 4 is a sectional view of an adhesive with a pressure regulation function (an adhesive tape with a pressure regulation function) according to an embodiment of the present invention, and an adherend, specifically illustrating a state after vapor release;

FIG. 5 is a graph that shows a water vapor pressure curve with respect to temperature; and

FIG. 6 is a graph that shows a water vapor pressure curve and shows how adhesive strength of adhesive of each of Example 5 and Comparative Example 1 varies with temperature.

### EMBODIMENTS

An adhesive with a pressure regulation function (hereinafter referred to simply as “an adhesive” in some cases) according to an embodiment of the present invention is described in detail below with reference to the drawings by exemplifying the case of being used in the form of an adhesive tape.

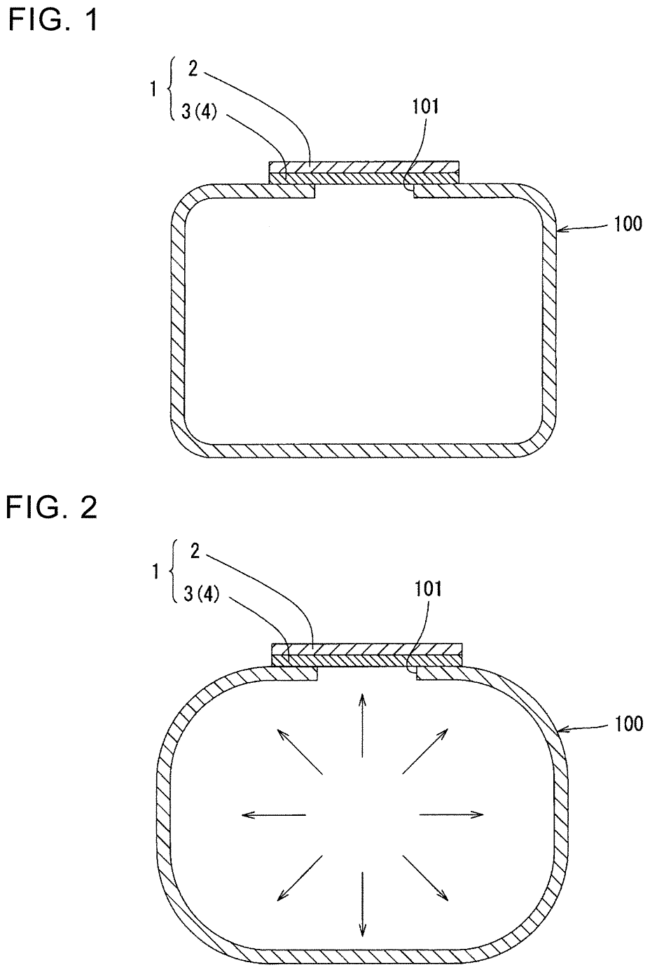

As illustrated in FIG. 1, an adhesive tape with a pressure regulation function (hereinafter referred to simply as “an adhesive tape” in some cases) 1 in the present embodiment includes a base 2 having a film shape, and an adhesive layer 3 laminated on at least one surface of the base 2.

The adhesive layer 3 includes an adhesive with the pressure regulation function 4 of the present embodiment. The adhesive layer 3 includes the adhesive 4 as a main component. The term “main component” as used herein is a component whose content in terms of weight ratio is higher than any other components. The main component may be, for example, 80% by weight or more. A content of the adhesive 4 in the adhesive layer 3 may be 80-100% by weight.

The adhesive 4 of the present embodiment is adhered to a resin adherend 100 including a vapor release port 101 in order to seal the vapor release port 101. The phrase “seal the vapor release port 101” as used herein is a concept that means not only sealing the vapor release port 101 before vapor release, but also resealing the vapor release port 101 after the vapor release. The vapor release port 101 serves as a part that permits release of vapor. Examples of shape of the vapor release port 101 may include a hole shape and a slit shape.

Examples of resin constituting the adherend 100 may include synthetic resins of polyethylene, polyethylene terephthalate (hereinafter referred to as “PET” in some cases), polypropylene, polyester, polystyrene, polyamide (hereinafter referred to as “nylon” in some cases), polyimide, polycarbonate, ethylene vinyl acetate copolymer, ethylene ethyl acrylate copolymer, ethylene polypropylene copolymer, or polyvinyl chloride.

The adherend 100 need not be made entirely of a resin. A neighborhood of the vapor release port 101 in the adherend 100, which is adhered by the adhesive 4, may be made of the resin. Therefore, the adherend 100 may include a part made of a material other than the resin in a region not adhered by the adhesive 4.

Examples of the adherend 100 may include containers used for the purpose of packaging. FIG. 1 illustrates a container as an example of the adherend 100. If the adherend 100 is the container, examples of content accommodated therein may one in which vapor, etc. generates with an increase in temperature. The adherend 100 may be subjected to surface treatment, such as printing.

The adhesive 4 of the present embodiment has the pressure regulation function. In other words, the adhesive 4 of the present embodiment is capable of performing the pressure regulation function, and is excellent in sealing properties and vapor releasability.

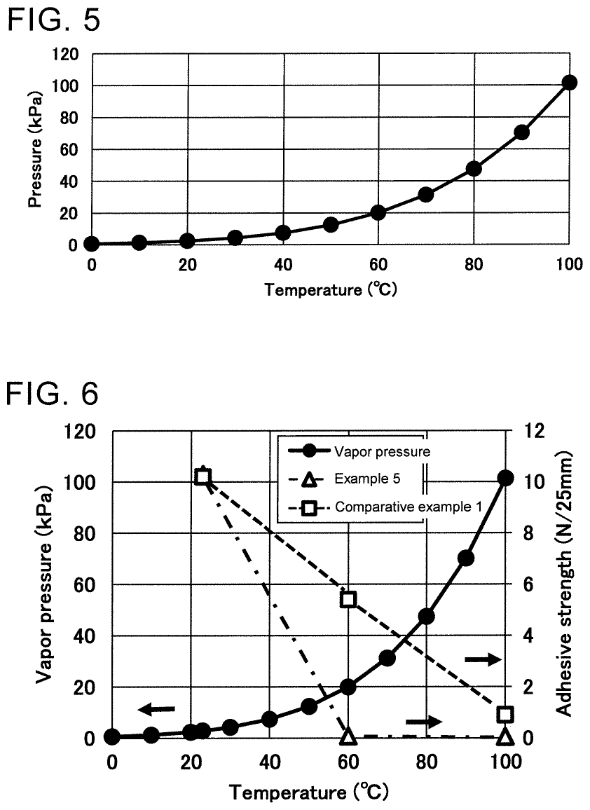

A saturated vapor pressure curve is shown in FIGS. 5 and 6, and a description is given by exemplifying vapor pressure. FIG. 5 shows a water vapor pressure curve relative to temperature. It can be seen from this diagram that the water vapor pressure increases sharply at approximately 60° C. FIG. 6 shows a water vapor pressure curve and a graph that shows how adhesive strength of the adhesives respectively according to Example 5 and Comparative Example 1 described later varies with temperature. The adhesive 4 of the present embodiment (Example 5) shown in FIG. 6 has low adhesive strength at 60° C. at which the vapor pressure increases sharply, and maintains such low adhesive strength even at 100° C. In contrast, adhesive strength of Comparative Example 1 reduces approximately linearly at room temperature (for example, 23° C.), 60° C., and 100° C.

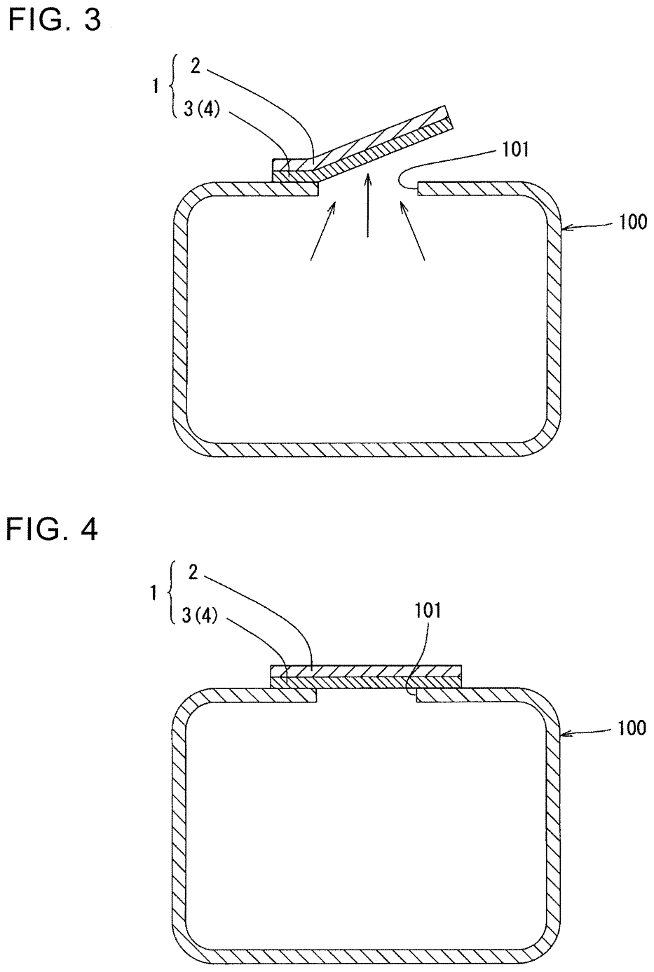

The above feature is described by applying it to a heating process in the present embodiment. As illustrated in FIG. 2, if the adherend 100 is heated, an internal temperature of the adherend 100 increases and an internal pressure of the adherend 100, that is, water vapor pressure increases. If the temperature of the adherend 100 reaches approximately 60° C., as illustrated in FIG. 3, the adhesive strength of the adhesive 4 reduces sharply. Consequently, the adhesive tape with the pressure regulation function 1 peels off from a surface of the adherend 100 by a pressure exerted on the vapor release port 101, and the vapor release port 101 opens to release vapor inside the adherend 100 to the outside.

In this case, the adhesive 4 needs to have high adhesive strength at room temperature and low adhesive strength at 60° C. The inside and the outside need to be separated from each other, and enough adhesive strength is required for sealing the vapor release port 101 at room temperature. The sharply increased vapor pressure needs to be reliably and efficiently released to the outside in order to prevent breakage of the adherend at 60° C. Accordingly, the adhesive strength of the adhesive 4 at 60° C. needs to be reduced sufficiently. The adhesive strength at 60° C. is preferably 2 N/25 mm or less, more preferably 1 N/25 mm or less. A method for measuring the adhesive strength is described later.

If the adhesive strength at 60° C. is a value larger than 2 N/25 mm, there is a possibility that water vapor may not be released sufficiently, and there is a possibility that the adherend 100 may be broken by pressure concentration. When the water vapor pressure in the inside increases around 60° C. by heating the adherend 100, the adhesive tape covering the vapor release port 101 is pressurized by the water vapor from the inside of the adherend 100. In some cases, if the adhesive strength at 60° C. is the value larger than 2 N/25 mm, the adhesive tape covering the vapor release port 101 may not peel off, resulting in breakage of the adherend 100. In another case, the adhesive tape covering the vapor release port 101 may not peel off uniformly, and a part whose adhesive strength is least, that is, only a part of the adhesive tape is more likely to peel off. In this case, the water vapor inside the adherend 100 is released in a concentrated manner from a partially peeled part of the vapor release port 101. Consequently, the water vapor may not be released sufficiently, or the adherend 100 may be broken by pressure concentration.

These points can be described more specifically by an adhesive strength reduction factor expressed in equation 1.

$$Adhesive Strength Reduction Factor = [ Adhesive strength at 23 ° C . ] / [ Adhesive strength at 60 ° C . ] \qquad Equation 1$$

The adhesive strength reduction factor is preferably 4 or more, more preferably 10 or more. If the adhesive strength reduction factor is 4 or more, it becomes possible to maintain adhesive strength at room temperature (for example, 23° C.), in other words, seal the vapor release port 101, and it becomes possible to reliably open the vapor release port 101 at 60° C. If the adhesive strength reduction factor is less than 4, the adhesive strength at room temperature is too low to seal the vapor release port 101, or it becomes difficult to reliably open the vapor release port 101 because of too high adhesive strength at 60° C.

Changes in adhesive strength of the adhesive 4 are settable in more detail by an adhesive strength change rate expressed in equation 2.

$$Adhesive Strength Change rate = [ Adhesive strength at 23 ° C . / Adhesive strength at 60 ° C . ] / [ Ratio of adhesive strength at 60 ° C . / adhesive strength at 100 ° C . ] \qquad Equation 2$$

The adhesive strength change rate is preferably 1 or more, more preferably 4 or more. FIG. 6 shows changes in vapor pressure and changes in adhesive strength. If the adhesive strength change rate is 1 or more, that is, a change in a range from 60° C. to 100° C. is smaller than a change in a range from 23° C. to 60° C., the adhesive strength of the adhesive 4 reduces significantly in a temperature range where the water vapor pressure increases sharply. Thereafter, it is possible to maintain the reduced adhesive strength of the adhesive 4, and the vapor release port 101 that has opened at 60° C. can be maintained in an open state even at 100° C.

In contrast, if the adhesive strength change rate is less than 1, that is, the change in the range from 60° C. to 100° C. is larger than the change in the range from 23° C. to 60° C., there is a possibility that the adhesive strength may not reduce sufficiently in the temperature range where the water vapor pressure inside the adherend 100 increases sharply, resulting in breakage of the adherend 100. If the adherend 100 is further subjected to continuous temperature rise, there is a possibility that an extremely increased water vapor pressure inside the adherend 100 may be released rapidly around 100° C., resulting in breakage of the vapor release port 101 and breakage of the adherend 100.

Additionally, as illustrated in FIG. 4, the adhesive 4 of the present embodiment is capable of resealing the vapor release port 101 after vapor release, and requires no external force for resealing. The adhesive 4 may be capable of resealing the vapor release port 101 without any human intervention. In this case, it is possible to obtain the effect that the adhesive 4 is also excellent in resealability.

It is considered that resealing is made possible by tack strength in a high temperature range, namely, in a temperature range of 60° C. or above. In a state where the vapor is already released from the vapor release port 101, the vapor is continuously released from the inside of the adherend 100 through the vapor release port 101 to the outside. Even in cases where a temperature rise stops and temperature drops gradually, the vapor is continuously released at temperatures up to approximately 60° C. With a conventional technology, even if an adhesive tape comes into contact with the vapor release port 101, the adhesive tape fails to stay there, and it has been difficult to reseal without any external force. The adhesive tape with the pressure regulation function 1 of the present embodiment has high tack strength at 60° C. and 100° C. in the high temperature range. When momentum of the vapor released from the vapor release port 101 becomes weaker and the adhesive 4 comes into contact with a circumference of the vapor release port 101, a temporarily adhered state is obtained by the high tack strength thereof. Then, if temperature is below 60° C. and the inside of the adherend 100 is depressurized gradually, the adhesive 4 adheres from a temporarily adhered portion by the tack strength to the circumference of the vapor release port 101, and it is thus possible to reseal the vapor release port 101. The tack strength of the adhesive 4 at 60° C. is preferably 3 N/19.6 mm² or more, more preferably 6 N/19.6 mm² or more. A method for measuring tack strength is described later.

The adhesive 4 of the present embodiment is excellent in sealing properties (fixing force) at room temperature (for example, 23° C.). The adhesive 4 of the present embodiment is also excellent in easy peelability during heating and in resealability after heating.

The adhesive 4 of the present embodiment may contain a pressure sensitive adhesive and a side chain crystalline polymer. This adhesive 4 is also called a temperature sensitive adhesive. The temperature sensitive adhesive is an adhesive whose adhesive strength varies with change in temperature. The case where the adhesive 4 is the temperature sensitive adhesive is described specifically below.

The pressure sensitive adhesive is a polymer having adhesiveness.

The side chain crystalline polymer includes, as a monomer component, (meth)acrylate having a straight-chain alkyl group with a carbon number of 12 to 30. In the (meth)acrylate having the straight-chain alkyl group with the carbon number of 12 to 30, the straight-chain alkyl group with the carbon number of 12 to 30 functions as a side chain crystalline unit in the side chain crystalline polymer. That is, the side chain crystalline polymer is a comb-shaped polymer whose side chain has the straight-chain alkyl group with the carbon number of 12 to 30, and the side chain is crystallized by being aligned into an ordered array by intermolecular force, etc.

The side chain crystalline polymer is also a polymer having a melting point. The melting point is a temperature at which a specific part of a polymer that is initially aligned into an ordered array is brought into a disordered state by a certain equilibrium process. The melting point is a value obtained by measurement under a measurement condition of temperature rise speed 10° C./min by using a differential scanning calorimeter (DSC).

The side chain crystalline polymer is crystallized at a temperature lower than the above melting point, and undergoes phase transition to show flowability at a temperature not lower than the melting point. That is, the side chain crystalline polymer has thermosensitivity that reversibly causes a crystalline state and a fluid state with change in temperature. Accordingly, because the side chain crystalline polymer is in the crystalline state at a temperature lower than the melting point, the adhesive 4 has enough adhesive strength with respect to a resin. Therefore, if the adhesive 4 is a temperature sensitive adhesive, the adhesive 4 shows excellent sealing properties (sealing properties or fixing force) at a temperature lower than the melting point.

Additionally, because the side chain crystalline polymer shows flowability at a temperature not lower than the melting point, the adhesiveness of the above pressure sensitive adhesive is inhibited. This results in reduced adhesive strength of the adhesive 4 with respect to the resin. That is, if the adhesive 4 is a temperature sensitive adhesive, the adhesive strength with respect to the resin reduces at a temperature not lower than the melting point of the side chain crystalline polymer. Therefore, the adhesive 4 shows excellent vapor releasability (easy peelability) at the temperature not lower than the melting point.

Further, if the adhesive 4 is the temperature sensitive adhesive, the adhesive 4 has high tack strength at high temperatures (for example, 100° C.), and is therefore excellent in resealability after vapor release (after heating). Furthermore, if the adhesive 4 is cooled to temperatures lower than the melting point of the side chain crystalline polymer, the adhesive strength is recovered by crystallization of the side chain crystalline polymer, thus leading to more excellent resealability.

As a (meth)acrylate having the straight-chain alkyl group with the carbon number of 12 to 30 that is the monomer component constituting the side chain crystalline polymer, there may be, for example, cetyl (meth)acrylate, stearyl (meth)acrylate, eicosyl (meth)acrylate, and behenyl (meth)acrylate. These exemplified (meth)acrylates may be used either singly or in combination of two or more kinds. The term “(meth)acrylate” as used herein means acrylate or methacrylate. The carbon number in the straight-chain alkyl group is preferably 16 to 30.

The monomer component constituting the side chain crystalline polymer may include other monomer copolymerizable with the (meth)acrylate having the straight-chain alkyl group with the carbon number of 12 to 30. Examples of other monomer may include (meth)acrylate having an alkyl group with a carbon number of 1 to 6, and polar monomers.

Examples of (meth)acrylate having an alkyl group with a carbon number of 1 to 6 may include methyl (meth)acrylate, ethyl (meth)acrylate, butyl (meth)acrylate, and hexyl (meth)acrylate. These exemplified (meth)acrylates may be used either singly or in combination of two or more kinds.

Examples of polar monomer may include ethylenically unsaturated monomers having a carboxyl group, such as acrylic acid, methacrylic acid, crotonic acid, itaconic acid, maleic acid, and fumaric acid, and ethylenically unsaturated monomers having a hydroxyl group, such as 2-hydroxyethyl (meth)acrylate, 2-hydroxypropyl (meth)acrylate, 4-hydroxybutyl (meth)acrylate, and 2-hydroxyhexyl (meth)acrylate. These exemplified polar monomers may be used either singly or in combination of two or more kinds.

A preferable composition of a side chain crystalline polymer, which contains (meth)acrylate having an alkyl group with a carbon number of 1 to 6 as a monomer component, but does not contain a polar monomer as a monomer component, includes 35-95% by weight of (meth)acrylate having a straight-chain alkyl group with a carbon number of 12 to 30, and 5-65% by weight of (meth)acrylate having an alkyl group with a carbon number of 1 to 6. A more preferable composition includes 35-80% by weight of (meth)acrylate having a straight-chain alkyl group with a carbon number of 12 to 30, and 20-65% by weight of (meth)acrylate having an alkyl group with a carbon number of 1 to 6.

A preferable composition of a side chain crystalline polymer, which contains, as a monomer component, (meth)acrylate having an alkyl group with a carbon number of 1 to 6, and a polar monomer, includes 30-95% by weight of (meth)acrylate having a straight-chain alkyl group with a carbon number of 12 to 30, 0-60% by weight of (meth)acrylate having an alkyl group with a carbon number of 1 to 6, and 5-10% by weight of a polar monomer. A more preferable composition includes 60-89% by weight of (meth)acrylate having a straight-chain alkyl group with a carbon number of 12 to 30, 10-30% by weight of (meth)acrylate having an alkyl group with a carbon number of 1 to 6, and 1-10% by weight of a polar monomer.

Examples of method for polymerizing a monomer component may include solution polymerization method, bulk polymerization method, suspension polymerization method, and emulsion polymerization method. In the case of employing the solution polymerization method, a monomer component and a solvent may be mixed together, and a polymerization initiator, a chain transfer agent, etc. may be added as needed. These may be allowed to react while stirring at approximately 40-90° C. for approximately 2-10 hours.

The melting point of the side chain crystalline polymer is preferably 100° C. or below, more preferably 30-80° C., even more preferably 30-60° C. In this case, excellent sealing properties (fixing force) is attainable at room temperature (for example, 23° C.). The melting point can be adjusted by changing, for example, a composition of a monomer component constituting the side chain crystalline polymer.

A weight average molecular weight of the side chain crystalline polymer is preferably 3000-20000, more preferably 5000-15000. In this case, it is possible to sufficiently reduce adhesive strength when the side chain crystalline polymer shows flowability. The weight average molecular weight is determined by gel permeation chromatography (GPC), and is a value obtained by calculating a determined value in terms of polystyrene.

A content of the side chain crystalline polymer is preferably 30 parts by weight or less, more preferably 3-20 parts by weight relative to 100 parts by weight of a pressure sensitive adhesive. In this case, when the side chain crystalline polymer shows flowability at a temperature not lower than the melting point, it is possible to sufficiently reduce the adhesive strength of the adhesive 4 with respect to a resin.

The pressure sensitive adhesive may be an acrylic pressure sensitive adhesive. Examples of a monomer component constituting the acrylic pressure sensitive adhesive may include (meth)acrylate having an alkyl group with a carbon number of 1 to 12. Examples of (meth)acrylate having an alkyl group with a carbon number of 1 to 12 may include 2-ethylhexyl (meth)acrylate, methyl (meth)acrylate, ethyl (meth)acrylate, and butyl (meth)acrylate. These exemplified (meth)acrylates may be used either singly or in combination of two or more kinds.

The pressure sensitive adhesive may include a polar monomer as a monomer component. The pressure sensitive adhesive may also include, as a monomer component, (meth)acrylate having an alkyl group with a carbon number of 1 to 6. Examples of the (meth)acrylate having an alkyl group with a carbon number of 1 to 6 and the polar monomer may include the same as those exemplified in the side chain crystalline polymer.

As a specific composition of the pressure sensitive adhesive, there may be, for example, the following compositions A and B.

Composition A including, as a monomer component, (meth)acrylate having an alkyl group with a carbon number of 1 to 12, and a polar monomer Composition B including, as a monomer component, (meth)acrylate having an alkyl group with a carbon number of 1 to 12, (meth)acrylate having an alkyl group with a carbon number of 1 to 6, and a polar monomer

The composition A may include 90-99% by weight of (meth)acrylate having an alkyl group with a carbon number of 1 to 12, and 1-10% by weight of a polar monomer. The composition B may include 40-65% by weight of (meth)acrylate having an alkyl group with a carbon number of 1 to 12, 30-50% by weight of (meth)acrylate having an alkyl group with a carbon number of 1 to 6, and 5-10% by weight of a polar monomer.

Examples of method for polymerizing a monomer component may include solution polymerization method, bulk polymerization method, suspension polymerization method, and emulsion polymerization method. In the case of employing the solution polymerization method, a monomer component and a solvent may be mixed together, and a polymerization initiator, a chain transfer agent, etc. may be added as needed. These may be allowed to react while stirring at approximately 40-90° C. for approximately 2-10 hours.

A weight average molecular weight of the pressure sensitive adhesive that is a polymer of the above monomer component is preferably 200,000-600,000, more preferably 300,000-500,000. The weight average molecular weight is determined by gel permeation chromatography (GPC), and is a value obtained by calculating a determined value in terms of polystyrene.

If 180° peel strength of the adhesive 4 with respect to a polyethylene terephthalate film at 100° C. is low, vapor releasability tends to improve. If the adhesive 4 has high tack strength at 100° C., resealability tends to improve.

The 180° peel strength of the adhesive 4 with respect to the polyethylene terephthalate film at 100° C. is preferably 0.3 N/25 mm or less, more preferably 0.2 N/25 mm or less. The tack strength of the adhesive 4 at 100° C. is preferably 2.0 N/19.6 mm² or more, more preferably 3.0 N/19.6 mm² or more. In these cases, the adhesive 4 is capable of showing stable vapor releasability and resealability with respect to the resin adherend 100 that is widely used for packaging.

The 180° peel strength is a value measured according to JIS Z0237. The tack strength is a probe tack value measured according to ASTM D 2979, except that a contact load is changed to 300 gf.

The adhesive 4 may further include a crosslinking agent. Examples of crosslinking agent may include aziridine compound, epoxy compound, metal chelate compound, and isocyanate compound. As crosslinking conditions, heating temperature is approximately 90-120° C., and heating time is approximately 1-20 minutes. A content of the crosslinking agent is preferably 0.1-10 parts by weight relative to 100 parts by weight of the pressure sensitive adhesive.

The adhesive tape 1 of the present embodiment includes the base 2 having the film shape as described above. The term “film-shape” as used herein is a concept that is not intended to limit to the film shape but includes the film shape or a sheet shape as long as it does not affect the effects of the present embodiment.

Examples of constituent material of the base 2 may include synthetic resins, such as polyethylene, polyethylene terephthalate, polypropylene, polyester, polyamide, polyimide, polycarbonate, ethylene vinylacetate copolymer, ethylene ethyl acrylate copolymer, ethylene polypropylene copolymer, and polyvinyl chloride.

A structure of the base 2 may be either a single-layer or multilayer structure. The base 2 may be subjected to surface treatment in order to enhance adhesion to the adhesive layer 3. Examples of surface treatment may include corona discharge treatment, plasma treatment, blast treatment, chemical etching treatment, and primer treatment.

A thickness of the base 2 is preferably 25-188 μm, more preferably 25-125 μm. If the thickness of the base 2 is 25-60 μm, vapor releasability tends to improve. If the thickness of the base 2 is 38-125 μm, resealability tends to improve.

If the adhesive layer 3 is laminated on at least one surface of the base 2, for example, an application liquid may be prepared by adding a solvent to the adhesive 4, and the obtained application liquid may be applied onto one or both surfaces of the base 2 by a coater, etc., followed by drying. Examples of coater may include knife coater, roll coater, calendar coater, comma coater, gravure coater, and rod coater.

A thickness of the adhesive layer 3 is preferably 5-100 μm, more preferably 5-50 μm.

If the adhesive layer is laminated on both surfaces of the base 2, the adhesive layer 3 on one surface and the adhesive layer 3 on the other surface may be identical or different in thickness, composition, etc. As long as the adhesive layer 3 on one surface includes the adhesive with the pressure regulation function 4 as described above, the adhesive layer on the other surface need not be particularly limited.

A release film may be laminated on a surface of the adhesive tape 1. As the release film, there may be, for example, one in which a release agent, such as silicone, is applied onto a surface of a film composed of polyethylene terephthalate, etc. A thickness of the release film is preferably 5-500 μm, more preferably 25-250 μm. The release film is peeled off when using the adhesive tape 1.

A form of use of the adhesive with the pressure regulation function as described above need not be in the form of an adhesive tape. For example, the adhesive may be used as it is, or may be used in the form of an adhesive sheet, etc. as described below.

An adhesive sheet with a pressure regulation function in the present embodiment (hereinafter referred to simply as “adhesive sheet” in some cases) includes the adhesive with the pressure regulation function as described above, and has a base-less sheet shape. A thickness of the adhesive sheet is preferably 5-100 μm, more preferably 5-50 μm.

The adhesive sheet includes the adhesive with the pressure regulation function as a main component. A content of the adhesive in the adhesive sheet may be 80-100% by weight.

A release film may be laminated on a surface of the adhesive sheet. Examples of release film may include the same as those exemplified in the adhesive tape 1 as described above. The release film is peeled off when using the adhesive sheet.

The present invention is described in detail below by exemplifying synthesis examples and examples. However, the present invention need not be the following synthesis examples and examples.

### (Synthesis Examples A, B, and C: Pressure Sensitive Adhesives)

Firstly, each of monomer mixtures was obtained by putting a monomer presented in Table 1 in a proportion presented in Table 1 into the reaction vessel. Monomers presented in Table 1 are as follows.
EHA: 2-ethylhexyl acrylate
AA: acrylic acid
C1A: methyl acrylate
HBA: 4-hydroxybutyl acrylate

Each of mixed solutions was obtained by adding a solvent presented in Table 1 so that a solid content concentration has a proportion presented in Table 1. Solvents presented in Table 1 are as follows.
EtAc: ethyl acetate
tol: toluene
hep: heptane

The obtained mixed solution was deaerated by nitrogen gas. Deaeration time was 30 minutes or more. Thereafter, the mixed solution was heated to 55° C., and peroxide “Perbutyl ND” manufactured by NOF CORPORATION was added in a proportion of 0.3 part by weight (in terms of solid content) relative to 100 parts by weight of the monomer mixture. The mixed solution was allowed to react for 4 hours.

Subsequently, the mixed solution was heated to 80° C., and peroxide “Perhexyl PV” manufactured by NOF CORPORATION was added in a proportion of 0.5 part by weight (in terms of solid content) relative to 100 parts by weight of the monomer mixture. The mixture was allowed to react for 2 hours, thereby obtaining a pressure sensitive adhesive.

### (Synthesis Examples D, E, F, and G: Side Chain Crystalline Polymer)

Firstly, each of monomer mixtures was obtained by putting a monomer presented in Table 1 in a proportion presented in Table 1 into a reaction vessel. Monomers presented in Table 1 are as follows.
C18A: stearyl acrylate
C1A: methyl acrylate
C22A: behenyl acrylate
AA: acrylic acid

Subsequently, dodecyl mercaptan as a chain transfer agent was added in a proportion of 5 parts by weight (in terms of solid content) relative to 100 parts by weight of the monomer mixture, and a solvent presented in Table 1 was also added to the reaction vessel so that a solid content concentration became a proportion presented in Table 1, thereby obtaining a mixed solution. The obtained mixed solution was deaerated by nitrogen gas. Deaeration time was 30 minutes or more.

Thereafter, the mixed solution was heated to 70° C., and the peroxide “Perhexyl PV” manufactured by NOF CORPORATION was added in a proportion of 0.5 part by weight (in terms of solid content) relative to 100 parts by weight of the monomer mixture. The mixed solution was allowed to react for 1 hour. Subsequently, the mixed solution was heated to 80° C., and was allowed to react for 4 hours, thereby obtaining a side chain crystalline polymer.

A weight average molecular weight of each of the obtained pressure sensitive adhesives are presented in Table 1. A weight average molecular weight and a melting point of each of the obtained side chain crystalline polymers are presented in Table 1. The weight average molecular weight is a value obtained by calculating, in terms of polystyrene, a determined value determined by GPC. The melting point is a value obtained by measurement under a measurement condition of temperature rise speed 10° C./min by using DSC.

TABLE 1

| | Monomer component | | Solvent | | | | Weight |
|---|---|---|---|---|---|---|---|
| | | Ratio | | Ratio | Solid content | Melting | average |
| | | (% by | | (% by | concentration | point | molecular |
| | Composition¹⁾ | weight) | Composition²⁾ | weight) | (% by weight) | (° C.) | weight |
| Synthesis Example A | EHA/AA | 95/5 | EtAc/tol | 85/15 | 35 | — | 410000 |
| Pressure Sensitive Adhesive | | | | | | | |
| Synthesis Example B | EHA/HBA | 95/5 | EtAc/hep | 70/30 | 38 | — | 450000 |
| Pressure Sensitive Adhesive | | | | | | | |
| Synthesis Example C | EHA/C1A/HBA | 52/40/8 | EtAc/tol | 70/30 | 32 | — | 410000 |
| Pressure Sensitive Adhesive | | | | | | | |
| Synthesis Example D | C18A/C1A | 60/40 | tol | 100 | 50 | 36 | 10000 |
| Side Chain Crystalline Polymer | | | | | | | |
| Synthesis Example E | C22A/C1A | 45/55 | tol | 100 | 50 | 50 | 9000 |
| Side Chain Crystalline Polymer | | | | | | | |
| Synthesis Example F | C18A/C1A | 40/60 | tol | 100 | 50 | 30 | 9000 |
| Side Chain Crystalline Polymer | | | | | | | |
| Synthesis Example G | C18A/C1A/AA | 75/20/5 | tol | 100 | 50 | 41 | 8000 |
| Side Chain Crystalline Polymer | | | | | | | |

¹⁾EHA: 2-ethylhexyl acrylate, AA: acrylic acid, C1A: methyl acrylate, HBA: 4-hydroxybutyl acrylate C18A: stearyl acrylate, C22A: behenyl acrylate
²⁾EtAc: ethyl acetate, tol: toluene, hep: heptane

### (Adhesive Strength to PET)

### Examples 1 to 12

### <Manufacturing of Adhesive Tapes>

Firstly, an application liquid was obtained by adding a crosslinking agent presented in Table 2 and the side chain crystalline polymer obtained in the synthesis examples in a combination and an addition presented in Table 2, to the pressure sensitive adhesive obtained in the synthesis examples. The additions presented in Table 2 are values in terms of solid content relative to 100 parts by weight of the pressure sensitive adhesive.

The crosslinking agents presented in Table 2 are as follows.
Aziridine-based: Aziridine compound “Chemite PZ-33” manufactured by Nippon Shokubai Chemical Industry Co., Ltd.
Epoxy-based: Epoxy compound “TETRAD-X” manufactured by Mitsubishi Gas Chemical Company, Inc.
Aluminum chelate-based: Aluminum tris(acetylacetonate), which is a metal chelate compound, manufactured by Kawaken Fine Chemicals Co. Ltd.
Isocyanate-based: Isocyanate compound “Coronate L-45E” manufactured by Nippon Polyurethane Industry Co., Ltd.

Subsequently, the obtained application liquid was applied onto one surface of the base, and was subjected to crosslinking reaction under conditions of 110° C. for 3 minutes, thereby obtaining an adhesive tape with an adhesive layer having a thickness of 30 μm laminated on the one surface of the base. The base was a PET film whose both surfaces was subjected to corona treatment and which had a thickness presented in Table 2.

A release film was laminated on a surface of the obtained adhesive tape. A lamination of the release film was carried out at room temperature (23° C.). The release film was a PET film having a thickness of 38 μm in which silicone was applied onto a surface thereof.

### Comparative Examples 1 and 2

Each of adhesive tapes was obtained in the same manner as in Examples 1 to 12, except that an application liquid was obtained by adding crosslinking agents presented in Table 2 in a combination and an addition presented in Table 2, to the pressure sensitive adhesive obtained in the synthesis examples. Each of evaluations was made under the same conditions as in Examples 1 to 12, except for using the adhesive tape thus obtained.

### <Evaluations>

The obtained adhesive tapes were evaluated in terms of adhesive strength, sealing properties at room temperature, and vapor releasability with respect to the PET film. Their respective evaluation methods are described below, and results thereof are presented in Table 2.

### (Adhesive Strength)

According to JIS Z0237, 180° peel strength with respect to the PET film at 23° C., 60° C., and 100° C. was measured. Specifically, the adhesive tape was applied to the PET film that was an adherend under the following conditions. Thereafter, the adhesive tape was peeled off at 180° (n=3) from the PET film that was the adherend at a speed of 300 mm/min by using a load cell. The PET film that was the adherend used here was one which had a film shape having a thickness of 0.025 mm and whose surface was untreated. In a column of the adhesive strength in Table 2, “(1)” indicates the adhesive strength reduction factor as described above, and “(1)/(2)” indicates the adhesive strength change rate as described above.

### [23° C.]

The adhesive tape was applied to the PET film that was the adherend at atmospheric temperature of 23° C. After leaving to stand at the atmospheric temperature for 20 minutes, the adhesive tape was peeled off at 180°.

### [60° C.]

The adhesive tape was applied to the PET film that was the adherend at atmospheric temperature of 23° C. After leaving to stand at the atmospheric temperature for 20 minutes, the atmospheric temperature was increased to 60° C. After leaving to stand at the atmospheric temperature for 5 minutes, the adhesive tape was peeled off at 180°.

### [100° C.]

The adhesive tape was applied to the PET film that was the adherend at atmospheric temperature of 23° C. After leaving to stand at the atmospheric temperature for 20 minutes, the atmospheric temperature was increased to 100° C. After leaving to stand at the atmospheric temperature for 5 minutes, the adhesive tape was peeled off at 180°.

### (Sealing Properties at Room Temperature)

Sealing properties at room temperature was evaluated from measurement results of the adhesive strength at 23° C. Evaluation standard was set as follows.
Symbol “⊚” (very good): 7.0 N/25 mm or more
Symbol “◯” (good): 5.0 N/25 mm or more and less than 7.0 N/25 mm
Symbol “x” (poor): less than 5.0 N/25 mm

### (Vapor Releasability)

Firstly, a test container was manufactured. Specifically, a slit part having a semicircular shape and a diameter of 10 mm was disposed at a midportion of the PET film having dimensions of 110 mm×110 mm and having a heat seal layer on one surface thereof. A lid material was obtained by applying, around the slit part, an adhesive tape processed into a shape of 30 mm×30 mm. Water was put in a cup container made of polypropylene which includes a flange part having a diameter of 100 mm and a width of 5 mm, and the lid material obtained above was crimped by heat-sealing, thereby manufacturing the test container.

The test container was subjected to heat treatment by a microwave oven under conditions of 500 W for 90 seconds, and vapor releasability was evaluated (n=5) by visually checking whether vapor was released from the slit part at the midportion without fracture of the heat seal part. Evaluation standard was set as follows.
Symbol “⊚” (very good): vapor release occurred five times out of five times
Symbol “◯” (good): vapor release occurred three or four times out of five times
Symbol “x” (poor): vapor release occurred two times or less out of five times

TABLE 2

| | | | | Side chain crystalline | | | |
|---|---|---|---|---|---|---|---|
| | Pressure | Crosslinking agent | | polymer | | Base | |
| | sensitive | | Addition | | Addition | PET | Adhesive |
| | adhesive | | (part by | | (part by | film | strength(N/25 mm) |
| | Composition | Composition | weight) | Compoisition | weight) | (μm) | 23° C. |
| Example 1 | A | Aziridine-based | 0.2 | D | 5 | 50 | 8.0 |
| Example 2 | A | Aziridine-based | 0.2 | D | 5 | 38 | 8.3 |
| Example 3 | A | Aziridine-based | 0.2 | D | 5 | 100 | 8.8 |
| Example 4 | A | Aziridine-based | 0.2 | E | 5 | 50 | 8.3 |
| Example 5 | A | Epoxy-based | 0.1 | D | 5 | 50 | 10.3 |
| Example 6 | A | Epoxy-based | 0.2 | D | 5 | 50 | 8.1 |
| Example 7 | A | Aluminum | 1.0 | D | 5 | 50 | 6.8 |
| | | chelate-based | | | | | |
| Example 8 | A | Epoxy-based | 0.2 | F | 5 | 50 | 7.2 |
| Example 9 | A | Epoxy-based | 0.2 | D | 10 | 50 | 7.5 |
| Example 10 | A | Epoxy-based | 0.2 | D | 15 | 50 | 8.5 |
| Example 11 | A | Epoxy-based | 0.2 | D | 20 | 50 | 6.8 |
| Example 12 | B | Isocyanate- | 0.2 | G | 5 | 50 | 6.8 |
| | | based | | | | | |
| Comparative | A | Epoxy-based | 0.2 | — | 0 | 50 | 10.2 |
| example 1 | | | | | | | |
| Comparative | C | Isocyanate- | 0.2 | — | 0 | 50 | 12.0 |
| example 2 | | based | | | | | |

| | Adhesive strength(N/25 mm) | | | | | Sealing | |
|---|---|---|---|---|---|---|---|
| | | (1) | | (2) | | properties at | |
| | | 23° C./ | | 60° C./ | (1)/ | room | Vapor |
| | 60° C. | 60° C. | 100° C. | 100° C. | (2) | temperature | releasability |
| Example 1 | 0.12 | 66.7 | 0.08 | 1.5 | 44.4 | ⊚ | ⊚ |
| Example 2 | 0.14 | 45.0 | 0.10 | 1.4 | 32.1 | ⊚ | ⊚ |
| Example 3 | 0.08 | 110.0 | 0.04 | 2.0 | 55.0 | ⊚ | ◯ |
| Example 4 | 0.14 | 59.3 | 0.09 | 1.6 | 38.1 | ⊚ | ⊚ |
| Example 5 | 0.08 | 128.8 | 0.05 | 1.6 | 80.5 | ⊚ | ⊚ |
| Example 6 | 0.07 | 115.7 | 0.01 | 7.0 | 16.5 | ⊚ | ⊚ |
| Example 7 | 0.05 | 136.0 | 0.01 | 5.0 | 27.2 | ◯ | ⊚ |
| Example 8 | 0.05 | 144.0 | 0.01 | 5.0 | 28.8 | ⊚ | ⊚ |
| Example 9 | 0.03 | 250.0 | 0.01 | 3.0 | 83.3 | ⊚ | ⊚ |
| Example 10 | 0.02 | 425.0 | 0.01 | 2.0 | 212.5 | ⊚ | ⊚ |
| Example 11 | 0.02 | 340.0 | 0.01 | 2.0 | 170.0 | ◯ | ⊚ |
| Example 12 | 0.02 | 340.0 | 0.01 | 2.0 | 170.0 | ◯ | ⊚ |
| Comparative | 5.4 | 1.89 | 0.9 | 6.00 | 0.31 | ⊚ | X |
| example 1 | | | | | | | |
| Comparative | 5.9 | 2.03 | 2.8 | 2.11 | 0.97 | ⊚ | X |
| example 2 | | | | | | | |

It is apparent from Table 2 that Examples 1 to 12 are excellent in easy peelability during heating. It is apparent that Examples 1 to 12 are excellent in sealing properties at room temperature and in vapor releasability with respect to the PET film.

### (Adhesive Strength to Nylon)

### Examples 13 to 18

### <Manufacturing of Adhesive Tapes>

Each of adhesive tapes was obtained in the same manner as in Examples 1 to 12, except that an application liquid was obtained by adding a crosslinking agent presented in Table 3 and the side chain crystalline polymer obtained in the synthesis examples to the pressure sensitive adhesive obtained in the synthesis examples in a combination and an addition presented in Table 3. The additions presented in Table 3 are values obtained by calculating in terms of solid content with respect to 100 parts by weight of the pressure sensitive adhesive. The crosslinking agents presented in Table 3 are the same as the crosslinking agents presented in Table 2. A release film was laminated on a surface of each of the obtained adhesive tapes in the same manner as in Examples 1 to 12.

### Comparative Examples 3 and 4

Adhesive tapes were obtained in the same manner as in Examples 13 to 18, except that an application liquid was obtained by adding a crosslinking agent presented in Table 3 to the pressure sensitive adhesives obtained in the synthesis examples in a combination and an addition presented in Table 3. Individual evaluations were made under the same conditions as in Examples 13 to 18, except for using the adhesive tapes thus obtained.

### Evaluations

The obtained adhesive tapes were evaluated in terms of adhesive strength, sealing properties at room temperature, and vapor releasability with respect to nylon. Their respective evaluation methods are described below, and results thereof are presented in Table 3.

### (Adhesive Strength)

Under the same conditions as in the adhesive strength to the PET, except that instead of the PET film, a nylon film was used in an adherend, 180° peel strength with respect to the nylon film at 23° C., 60° C., and 100° C. was measured. The nylon film used here was one which had a film shape having a thickness of 0.015 mm and whose surface was untreated.

### (Sealing Properties at Room Temperature)

Evaluation was made under the same conditions as in the sealing properties at room temperature in the adhesive strength to the PET.

### (Vapor Releasability)

A test container was manufactured in the same manner as in the vapor releasability in the adhesive strength to the PET, except that a lid material was obtained using a nylon film instead of the PET film. Evaluation was made under the same conditions as in the vapor releasability in the adhesive strength to the PET, except for using the test container thus obtained.

TABLE 3

| | | | | Side chain crystalline | | | |
|---|---|---|---|---|---|---|---|
| | Pressure | Crosslinking agent | | polymer | | Base | |
| | sensitive | | Addition | | Addition | PET | Adhesive |
| | adhesive | | (part by | | (part by | film | strength(N/25 mm) |
| | Composition | Composition | weight) | Compoisition | weight) | (μm) | 23° C. |
| Example 13 | A | Epoxy-based | 0.2 | D | 5 | 50 | 7.8 |
| Example 14 | A | Epoxy-based | 0.2 | F | 5 | 50 | 6.2 |
| Example 15 | A | Epoxy-based | 0.2 | D | 10 | 50 | 7.3 |
| Example 16 | A | Epoxy-based | 0.2 | D | 15 | 50 | 6.8 |
| Example 17 | A | Epoxy-based | 0.2 | D | 20 | 50 | 6.5 |
| Example 18 | B | Isocyanate- | 0.2 | G | 5 | 50 | 7.8 |
| | | based | | | | | |
| Comparative | A | Epoxy-based | 0.2 | — | 0 | 50 | 8.2 |
| example 3 | | | | | | | |
| Comparative | C | Isocyanate- | 0.2 | — | 0 | 50 | 7.8 |
| example 4 | | based | | | | | |

| | Adhesive strength(N/25 mm) | | | | | Sealing | |
|---|---|---|---|---|---|---|---|
| | | (1) | | (2) | | properties at | |
| | | 23° C./ | | 60° C./ | (1)/ | room | Vapor |
| | 60° C. | 60° C. | 100° C. | 100° C. | (2) | temperature | releasability |
| Example 13 | 0.9 | 8.67 | 0.5 | 1.80 | 4.81 | ⊚ | ◯ |
| Example 14 | 0.4 | 15.5 | 0.2 | 2.00 | 7.75 | ◯ | ◯ |
| Example 15 | 0.8 | 9.13 | 0.4 | 2.00 | 4.56 | ⊚ | ◯ |
| Example 16 | 0.6 | 11.3 | 0.3 | 2.00 | 5.67 | ◯ | ◯ |
| Example 17 | 0.5 | 13.0 | 0.3 | 1.67 | 7.80 | ◯ | ◯ |
| Example 18 | 0.2 | 39.0 | 0.07 | 2.86 | 13.7 | ⊚ | ⊚ |
| Comparative | 2.3 | 3.87 | 0.8 | 3.83 | 0.93 | ⊚ | X |
| example 3 | | | | | | | |
| Comparative | 2.1 | 3.71 | 0.5 | 4.20 | 0.88 | ⊚ | X |
| example 4 | | | | | | | |

It is apparent from Table 3 that Examples 13 to 18 are excellent in easy peelability during heating. It is apparent that Examples 13 to 18 are excellent in sealing properties at room temperature and in vapor releasability with respect to the nylon film.

### (Tack Strength)

### Examples 19 to 30

### <Manufacturing of Adhesive Tapes>

Each of adhesive tapes was obtained in the same manner as in Examples 1 to 12, except that an application liquid was obtained by adding a crosslinking agent presented in Table 4 and the side chain crystalline polymer obtained in the synthesis examples in a combination and an addition presented in Table 4, to the pressure sensitive adhesive obtained in the synthesis examples. The additions presented in Table 4 are values in terms of solid content relative to 100 parts by weight of the pressure sensitive adhesive. The crosslinking agents presented in Table 4 are the same as the crosslinking agents presented in Table 2. A release film was laminated on a surface of each of the obtained adhesive tapes in the same manner as in Examples 1 to 12.

The obtained adhesive tapes were evaluated in terms of tack strength and resealability. Their respective evaluation methods are described below, and results thereof are presented in Table 4.

### (Tack Strength)

A probe tack value was measured at 23° C., 60° C., and 100° C. according to ASTM D 2979, except that a contact load was changed to 300 gf.

### (Resealability)

It was evaluated whether resealing occurred without applying any external force after the evaluation in terms of “vapor releasability” in the adhesive strength to the PET as described above. Evaluation standard was set as follows.
Symbol “⊚” (very good): resealing occurred 5 times out of five times
Symbol “◯” (good): resealing occurred three or four times out of five times
Symbol “x” (poor): resealing occurred two times or less out of five times

### Comparative Example 5

An adhesive tape was obtained in the same manner as in Examples 19 to 30, except that an application liquid was obtained by adding a crosslinking agent presented in Table 4 and a foaming agent described later to the pressure sensitive adhesive obtained in the synthesis examples in a combination and an addition presented in Table 4. Individual evaluations were made under the same conditions as in Examples 19 to 30, except for using this adhesive tape. Results thereof are presented in Table 4.

Foaming Agent: Thermally expandable microcapsule “551DU40” manufactured by EXPANCEL Inc., having a mean particle diameter of 10-16 μm and a foaming temperature of 90° C. or above

TABLE 4

| | | | | Side chain crystalline | | Foaming | | | | | |
|---|---|---|---|---|---|---|---|---|---|---|---|
| | Pressure | Crosslinking agent | | polymer | | agent | Base | | | | |
| | sensitive | | Addition | | Addition | Addition | PET | Tack Strength | | | |
| | adhesive | | (part by | | (part by | (part by | film | (N/19.6 mm²) | | | |
| | Composition | Composition | weight) | Compoisition | weight) | weight) | (μm) | 23° C. | 60° C. | 100° C. | Resealability |
| Example 19 | A | Aziridine-based | 0.2 | D | 5 | 0 | 50 | 10.7 | 8.1 | 5.4 | ⊚ |
| Example 20 | A | Aziridine-based | 0.2 | D | 5 | 0 | 38 | 11.5 | 7.4 | 4.3 | ◯ |
| Example 21 | A | Aziridine-based | 0.2 | D | 5 | 0 | 100 | 10.5 | 7.8 | 4.4 | ⊚ |
| Example 22 | A | Aziridine-based | 0.2 | E | 5 | 0 | 50 | 11.9 | 7.5 | 4.4 | ⊚ |
| Example 23 | A | Epoxy-based | 0.1 | D | 5 | 0 | 50 | 12.2 | 8.1 | 5.4 | ⊚ |
| Example 24 | A | Epoxy-based | 0.2 | D | 5 | 0 | 50 | 10.8 | 7.2 | 4.3 | ⊚ |
| Example 25 | A | Aluminum | 1.0 | D | 5 | 0 | 50 | 10.7 | 7.3 | 3.7 | ⊚ |
| | | chelate-based | | | | | | | | | |
| Example 26 | A | Epoxy-based | 0.2 | F | 5 | 0 | 50 | 8.7 | 6.7 | 3.9 | ⊚ |
| Example 27 | A | Epoxy-based | 0.2 | D | 10 | 0 | 50 | 10.5 | 7.2 | 3.9 | ⊚ |
| Example 28 | A | Epoxy-based | 0.2 | D | 15 | 0 | 50 | 9.6 | 6.9 | 3.5 | ⊚ |
| Example 29 | A | Epoxy-based | 0.2 | D | 20 | 0 | 50 | 9.5 | 6.5 | 3.3 | ⊚ |
| Example 30 | B | Isocyanate- | 0.2 | G | 5 | 0 | 50 | 9.2 | 6.5 | 4.9 | ⊚ |
| | | based | | | | | | | | | |
| Comparative | C | Isocyanate- | 1.0 | — | 0 | 20 | 50 | 6.0 | 2.7 | 0.1 | X |
| example 5 | | based | | | | | | | | | |

It is apparent from Table 4 that Examples 19 to 30 achieved resealability (resealing properties) after heating without applying any external force. It is apparent that Examples 19 to 30 are excellent in resealability.

### DESCRIPTION OF THE REFERENCE NUMERAL

1 adhesive tape with pressure regulation function
2 base
3 adhesive layer
4 adhesive with pressure regulation function
100 adherend
101 vapor release port

1. An adhesive with a pressure regulation function configured to be adhered to a resin adherend comprising a vapor release port in order to seal the vapor release port,
wherein adhesive strength reduces by heat of vapor released from the vapor release port, and peeling occurs to release vapor by pressure of vapor.

2. The adhesive with the vapor release function according to claim 1, wherein the vapor release port is resealable after vapor release, and no external force is required for resealing.

3. The adhesive with the vapor release function according to claim 1, wherein the adhesive comprises
a pressure sensitive adhesive, and
a side chain crystalline polymer comprising, as a monomer component, (meth)acrylate having a straight-chain alkyl group with a carbon number of 12 to 30.

4. The adhesive with the vapor release function according to claim 3, wherein adhesive strength to a resin reduces at a temperature not lower than a melting point of the side chain crystalline polymer.

5. An adhesive sheet with a pressure regulation function, comprising the adhesive with the pressure regulation function according to claim 1.

6. An adhesive tape with a pressure regulation function, comprising:
a base having a film shape; and
an adhesive layer that is laminated on at least one surface of the base and comprises the adhesive with the pressure regulation function according to claim 1.
